(19) United States
(12) Patent Application Publication
(10) Pub. No.: US 2004/0230581 A1
(43) Pub. Date: Nov. 18, 2004

(54) Processing distributed mobile queries with interleaved remote mobile joins

(76) Inventor: Chang-Hung Lee, Yun-Lin Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/438,021

(22) Filed: May 15, 2003

(51) Int. Cl. G06F 17/30

(52) U.S. Cl. 707/10

(57) ABSTRACT

The query processing in a mobile computing environment involves join processing among different sites which include static servers and mobile computers. Because of the presence of asymmetric features in a mobile computing environment, the conventional query processing for a distributed database cannot be directly applied to a mobile computing system. Remote mobile joins are said to be effectual if they are, when being interleaved into a join sequence, able to reduce the amount of data transmission cost required for distributed mobile query processing. With proper scheduling, interleaving effectual remote mobile joins into a query scheduling can significantly reduce the total amount of data transmission among different sites. The present invention approach of interleaving the processing of distributed mobile queries with effectual remote mobile joins is not only efficient, but also effective in reducing the total amount of data transmission cost required to process distributed mobile queries.

### BACKGROUND OF INVENTION

1. Field of the Invention

The present invention relates to a method for processing distributed mobile queries, and more specifically, to a scheduling algorithm for processing distributed mobile queries with remote mobile joins.

2. Description of the Prior Art

1 Introduction

Recently, the need for accessing information from anywhere at any time has been a driving force for a variety of portable devices and mobile applications. As the number of mobile applications increases rapidly, there has been a growing demand for the use of distributed database architectures for various applications. Applications such as stock activities, traffic reports, and weather forecasts have become increasingly popular. Various wireless data networking technologies, including IS-136, CDMA2000, Wireless Application Protocol (WAP), and third generation mobile phone, have been developed. Among others, with the rapid advances in palm computer technologies, a mobile computer is envisioned to be equipped with more powerful capabilities, including the storage of a small database and the capacity of data processing. Consequently, the query processing in a mobile computing system which involves fixed hosts and several mobile computers has emerged as an issue of growing importance.

Generally, there are three primary types of wireless mobile networks. The first one is known as an infrastructured network, i.e., a network with fixed and wired base stations. These base stations act as the gateways between high-speed wired networks and low-bandwidth wireless networks. A mobile device within these networks connects to the nearest base station with a wireless connection when the device is inside the service area of the base station. A handoff occurs when a mobile device moves from one service area to another. Examples of this type of networks include GPRS and 3G. The second type of networks is known as infrastructure-less networks, which is also known as mobile ad hoc networks (referred to as MANETs). MANETs do not have fixed nodes and all nodes are capable of movement and can be connected dynamically. In addition to end hosts, mobile nodes of these networks also function as routers which discover and maintain routes, and forward packets to other nodes. A number of standards have been developed to support MANETs, including IEEE 802.11, HomeRF, and Bluetooth. Example applications of MANETs include digital battlefield communications, personal area networks, and sensor networks. Third, several hybrid network architectures, e.g., IEEE 802.16, have been proposed to integrate heterogeneous networks to provide high availability and high bandwidth mobile computing environments.

On the other hand, a considerable amount of research effort on mobile database issues has been elaborated upon in recent years. These studies cover a broad spectrum of topics including:

1. data replication in infrastructured networks and MANETs;

2. data broadcasting and dissemination strategy;

3. caching design;

4. mobility management;

5. location-dependent data query processing and caching; and

6. transaction management.

Conventionally, as pointed out by C. T. Yu and C. C. Chang in “Distributed Query Processing,” ACM Computing Surveys, vol.16, no. 4, pp. 399-433, December 1984, the processing of a distributed query is composed of the following three phases: 1) local processing phase, 2) reduction phase, and 3) final processing phase. Significant research efforts have been focused on the problem of reducing the amount of data transmission required for phases 2) and 3) of distributed query processing. The semijoin and join operations have received a considerable amount of attention and have been extensively studied in the literature, as M. S. Chen and P. S. Yu explain in “A Graph Theoretical Approach to Determine a Join Reducer Sequence in Distributed Query Processing,” IEEE Trans. Knowledge and Data Eng., vol. 6, no. 1, pp. 152-165, February 1994. In addition, relevant works on query processing include client-server-based query processing, mobile computing query processing, query processing on the Web, and network-based ones, to name a few. However, as will be explained later, without considering network characteristics and asymmetric computing capability, the conventional approach for distributed query processing cannot be directly applied to the mobile computing environment nowadays.

Consider an inventory application, for example, where a salesperson uses, for his/her work, a mobile computer device in which a fragment of database contains the information of his/her customer records. In FIG. 1, a portable computer, such as M₂, is hand-carried by this salesperson and is located at Cell₁ while F₁ and M₃ are also located at the same region Cell₁. On the other hand, F₄, M₅, and M₆ with different data sets are allocated at Cell₂. F₁ and F₄ represent fixed hosts and M₂, M₃, M₅, and M₆ are mobile hosts. Note that, depending on the corresponding coherency control mechanism employed, the data copy in the fixed host server could be obsolete. Since the most up-to-date data is stored in the mobile computers, a query generated by a salesperson could be a sequence of joins to be performed across the relations residing in the server and several mobile computers, resulting in a very different execution scenario from the one for query processing in a traditional distributed system. Furthermore, mobile computers use small batteries for their operations without directly connecting to any power source and the bandwidth of wireless communication is, in general, limited. As a result, how to conserve the computing capability and communication bandwidth of a mobile unit while allowing mobile users of the ability to access information from anywhere at any time has become an important design issue in a mobile system.

Consequently, we shall explore in this disclosure three important asymmetric features of a mobile computing system and, in light of these features, develop corresponding query processing schemes for mobile computing systems. The first asymmetric feature is on the computing capability between fixed hosts and mobile hosts. Usually, mobile computers have limited resources for their computing operations and the server is certainly much more powerful than a portable computing device. Note that, in traditional distributed query processing, the sites involved in a query processing are usually assumed to have the same level of processing capability, which is, however, not valid in a mobile environment. The second asymmetric feature is on the transmission bandwidth between fixed hosts and mobile hosts. Clearly, the transmitting capability among mobile hosts is smaller than that among fixed hosts since the transmission bandwidth of fixed hosts is, in general, much larger than that of mobile hosts. The third asymmetric feature is on the transmission cost coefficients among local hosts and remote hosts. The transmission cost required for transmitting one unit of data among local hosts is much smaller than the corresponding cost required among remote hosts. These features distinguish the query processing in a mobile environment from the one in a traditional distributed system and, hence, have to be considered when the costs of the corresponding operations are modeled.

Due to the presence of asymmetric features in a mobile computing environment, the conventional query processing for a distributed database cannot be directly applied to a mobile computing system. In view of this, we shall explicitly devise query processing methods for both joins and query processing. Remote mobile joins are said to be effectual if they are, when being interleaved into a join sequence, able to reduce the amount of data transmission cost required for distributed mobile query processing. Since mobile relations are employed as reducers in our proposed query processing cost model, more mobile joins in the query processing lead to less data transmitted through the network. Instead of processing queries by performing the minimum-cost joins sequentially, as with conventional methodologies, interleaving effectual remote mobile joins into a query scheduling can significantly reduce the total amount of data transmission among different cells. It can be verified that the total data transmission cost of the processing in a distributed mobile query can be reduced by the algorithms devised in this disclosure by using effectual remote joins. Performance studies on the sensitivity of various important parameters, including the number of mobile relations in a cell architecture, the density of query, the number of relation tuples, the amount of an attribute cardinality, and network transmission coefficients in a mobile computing model, are also conducted. It is shown by our simulation results that, by exploiting three asymmetric features, the effectual remote mobile joins proposed are very powerful in reducing the amount of data transmission cost incurred and can lead to the design of an efficient and effective query processing procedure for a mobile computing environment.

We mention in passing that, without dealing with query processing, the issues of optimization between energy consumption and server workload in a mobile environment have been studied before. Several research efforts have elaborated upon developing a location dependent query mechanism. Without exploiting the network characteristics and asymmetric features of computing capability, the attention of prior studies was mainly paid to the query mechanisms with location constraints and query processing in traditional distributed databases, but not to the specific cost model and the query processing for a mobile computing system explored in this disclosure. As mentioned above, due to these asymmetric features of a mobile computing system, the cost model and the design of query processing schemes are different from those in a traditional distributed database.

2 Preliminaries

As in most previous works in distributed databases, we assume a query is in the form of conjunctions of equi-join predicates and all attributes are renamed in such a way that two join attributes have the same attribute name if and only if they have a join predicate between them. |K| is used to denote the cardinality of a set K. For notational simplicity, the width of an attribute A and that of a tuple in R₁ are assumed to be one unit. The size of the total amount of data in Rᵢ can then be denoted by |Rᵢ|. |A| is used to denote the cardinality of the domain of an attribute A. Define the selectivity ρ_{i,a} of attribute A in Rᵢ as

$$\frac{{R}_{i} ( A )}{\vert A \vert} ,$$

where Rᵢ (A) is the set of distinct values for the attribute A in Rᵢ.Rᵢ−A→Rⱼ means a semijoin from Rᵢ to Rⱼ on attribute A. After the semijoin Rᵢ−A→Rⱼ, the cardinality of Rⱼ can be estimated as |Rⱼ|ρ_{i,a}. To simplify the notation, Rᵢ→Rⱼ is used to mean a semijoin from Rᵢ to Rⱼ in the case that the semijoin attribute does not have to be specified. Also, the notation Rᵢ [symbol] Rⱼ is used to mean that Rᵢ is sent to the site of Rⱼ and a join operation is performed with Rⱼ there. We use R′ᵢ to denote the resulting relation after joins/semijoins are applied to an original relation Rᵢ.

Consider the relations in FIG. 2. Suppose |A|=5, |B|=10, and the width of each attribute is one unit. In addition, we have ρ_{1,b}=0.3 and ρ_{2,b}=0.6. Also, |R₁|=5, |R₂|=7, R₁(B)={b₁, b₃, b₄}, and R₁.B=R₂.B.

Conventionally, a function of the form C(X)=c₀+c₁.X is used to characterize communication cost, where X is the amount of data shipped from one site to another, c₁ is the communication cost per data unit, and the start-up connection cost c₀ is usually less significant. However, if the network topology is taken into consideration, the notion of identifying a profitable semijoin that prior work relied upon is incomplete and, in fact, might be misleading in some cases. Explicitly, c₁ is not a constant when network characteristics are considered and its value is dependent upon the network topology.

In general, it is very difficult to determine a network cost model since the practical transmission bandwidth for a network traffic is in fact time-dependent. Hence, statistical values of transmission bandwidth of the network are employed to provide a proper solution. Note that, even though the temporal traffic is not a constant value and almost unpredictable in the present network, utilizing a statistical average to optimize the scheduling of query processing in a mobile environment will limit the error of scheduling to an acceptable range. Nevertheless, due to the fast development of QoS techniques in the next generation mobile units, IEEE 802.11a/b and IEEE 802.16, the network traffic is envisioned to become more stable in coming years. As a consequence, the transmission coefficient c_{m→n} is used to serve as the statical average value in each network edge. We define an effectual semijoin as follows.

Definition 1 (Effectual Semijoin). A semijoin, R₁(S₁)−B→R₂(S₂), is called effectual if its cost of sending R₁(B), i.e., c_{1→2}(|R₁(B)|=|B|ρ_{1,b}), is smaller than its benefit, i.e., c_{2→1}(|R₂|−|R₂|ρ_{1,b}=|R₂|(1−ρ_{1,b})), where R₁ and R₂ are located at sites S1 and S2, respectively, and |R₂| and |R₂|ρ_{1,b} represent, respectively, the sizes of R₂ before and after the semijoin. Thus, |R₁(B)|c_{1→2} is used to denote the cost of a semijoin R₁−B→R₂.

Note that |R₁(B)|=1×3 and |R₂|(1—ρ_{1,b})=1×7×0.7=4.9, as illustrated in the example above. If R₁−B→R₂ is effectual, then c_{1→2} should be smaller than

$$\frac{4.9}{3} \times {{c}_{2}}_{\to 1} .$$

Otherwise, if c_{2→1}(|R₂(B)|)<c_{1→2}(R|(1−ρ_{2,b})), then R₂(S₂)−B→R₁(S₁) is an effectual semijoin. Different transmission paths with different transmission coefficients will lead to different transmission costs though the amount of data transmission is the same. Thus, the scheduling of query processing will be significantly influenced by the transmission coefficients among network characteristics. In general, the path with higher bandwidth and lower communication costs, such as the local communication with fixed hosts, is associated with a lower transmission cost coefficient. The remote mobile communication, in contrast, is certainly more expensive than the local one.

Furthermore, we assume that the values of attributes are uniformly distributed over all tuples in a relation and that the values of one attribute are independent from each other. Note that this assumption is not essential, but will simplify our presentation. In the presence of certain database characteristics and data skew, we only have to modify the formula for estimating the cardinalities of resulting relations from joins accordingly.

2.1 Cost Model

Consequently, we derive a cost model which considers these three asymmetric features of a mobile computing system. Our model consists of two distinct sets of entities: mobile hosts and fixed hosts. Furthermore, we use local and remote to indicate two different communication modes. Local communication means that the transmission is among hosts in the same cell, whereas remote communication means that the transmission is among different cells. For ease of our discussion, symbols used are shown in FIG. 3. c_{FF}^{L} denotes local transmission cost coefficient among fixed hosts and we assume c_{FF}^{L} is a basic coefficient and its value is given as one unit for transmitting one unit of data among local fixed hosts. The local transmission cost coefficient among mobile hosts is denoted by c_{MM}^{L}. Analogously, we use c_{MF}^{L} to indicate the local transmission cost coefficient between mobile hosts and fixed hosts. For remote communication, we have three parameters to model the transmission costs among mobile and fixed hosts, i.e., c_{FF}^{R}, c_{MM}^{R}, and c_{MF}^{R}. In addition, several transmission cost ratios are used to represent the relationship among these transmission coefficients, i.e.,

$${r}_{FF}^{RL} = \frac{{c}_{FF}^{R}}{{c}_{FF}^{L}} , {r}_{MM}^{RL} = \frac{{c}_{MM}^{R}}{{c}_{MM}^{L}} , {r}_{MF}^{L} = \frac{{c}_{MM}^{L}}{{c}_{FF}^{L}} , and {r}_{MF}^{R} = \frac{{c}_{MM}^{R}}{{c}_{FF}^{R}} .$$

Note that the processing time in each computing host may vary and its system dependent optimization is a challenging issue itself and is beyond the scope of this disclosure.

3 Query Processing in a Mobile Computing System

Join processing in a mobile computing system is discussed in Section 3.1. The query processing scheme with a divide-and-conquer technique based on the cell architecture (to be referred to as scheme QP_{C}) is discussed in Section 3.2. The scheme that is devised with effectual remote mobile joins (to be referred to as scheme QP_{R}) is described in Section 3.3. Moreover, the solution searching space is analyzed in Section 3.4.

3.1 Join Processing in a Mobile Computing System

We now derive the solution procedure for minimizing the cost of join methods in a mobile computing system. Consider the scenario of join processing in FIG. 4, where the fixed host F₁ has relation R₁ and the fixed hosts F₂ has relation R₂.R₃ is located at the mobile host M₃. Suppose that the mobile user M₃ submits a query that performs a join operation of R₁, R₂, and R₃ on their common attribute A and B, R₁.A=R₃.A and R₂.B R₃.B, with the corresponding selectivity factors A and B, respectively. We will select F₁ as the location for storing the join result. With this given model, we shall examine two join methods. To simplify our presentation, TC(J) is used to represent the data transmission cost of the join method J.

In what follows, we examine a join sequence which performs the joins based on cell architecture with a divide-and-conquer technique in Section 3.1.1. Section 3.1.2 describes the effectual remote mobile join method. Analysis of these join methods is given in Section 3.1.3.

3.1.1 Processing Joins with Divide-and-Conquer (Denoted by J_{C})

Consider a query in FIG. 4 as an example. Traditionally, the query processing is performed based on the minimum-cost join in a forward-scheduling manner. Since the transmission cost among local communication paths is more inexpensive than that among remote communication paths, the query will be naturally divided into two separated subqueries based on the cell architecture and processed independently. This is how the notion of divide and conquer comes out. One is the subquery belonging to the communication cell Cell₁ and the other is belonging to Cell₂. After the join results of each subquery are merged into a fixed host, the residue relations can be processed with the new query. Such a processing scenario is shown in FIG. 5. Note that, with the forward scheduling method, the join processing, merging the partial database R₃ on M₃ to R₁ of F₁, will be the most efficient processing. As a result, a cost of TC(R₃ [symbol] R₁)=c_{MF}^{L}*|R₃| is incurred and a new relation R′₁ is generated in F₁, where

$$\vert {R}_{1}^{′} \vert = \frac{\vert R1 \vert \vert R3 \vert}{\vert A \vert} .$$

After all of the local join sequences in each subquery are finished, two separated subqueries are merged to be a new query, i.e., R′₁.B=R₂.B between F₁ and F₂. Since the amount of tuples storing in the fixed host database is much larger than the number of an attribute cardinality, i.e., both |R₁| and |R₂| are much larger than |B| in a mobile environment, an effectual semijoin occurs between these two residual relations in fixed hosts. Because of |R₁|>>|B|, ρ_{1,B} is assumed to be unchanged after the join processing. In other words, a semijoin R′₁−B→R₂ and a join R′₂ [symbol] R′₁ will be processed in this merged query, which leads to a cost of TC(R′₁−B→R₂)+TC(R′₂ [symbol] R′₁)=c_{FF}^{R}*|R′₁(B)|+c_{FF}^{R}*ρ_{1,B}*|R₂|. Then, the corresponding costs is summarized as follows: TC(J_{C})=C_{MF}^{L}*|R₃|+C_{FF}^{R}ρ_{1,B}*(|B|+|R₂|).

3.1.2 Processing Joins with Remote Mobile Join (Denoted by J_{R})

Next, consider the case of join processing with remote mobile joins. Instead of merging the join operation between F₁ and M₃, R₃ is merged to R₂, followed by the join processing between F₁ and F₂. Even though the remote transmission cost coefficient between mobile hosts and fixed hosts, i.e., c_{MF}^{R}, is much larger than the local transmission cost between mobile hosts and fixed hosts, i.e., c_{MM}^{L}, it can be still profitable with a high reduction ratio leading to the use of an effectual remote mobile join. As shown in the execution scenario in FIG. 6, the total transmission cost will be TC(R₃ [symbol] R₂)+TC(R₁−B→R′₂)+TC(R″₂ [symbol] R₁), where TC(R₃ [symbol] R₂)=c_{MF}^{R}*|R₃|, TC(R₁−B→R′₂)+TC(R″₂ [symbol] R₁)=c_{FF}^{R}*(ρ_{1,B}*|B|+|R″₂ and

$$\vert {R}_{2}^{″} \vert = {ρ}_{1 , B} \frac{\vert R1 \vert \vert R3 \vert}{\vert A \vert} .$$

Consequently, we have corresponding costs below.

$$T C ( {J}_{R} ) = {c}_{M F}^{R} * \vert {R}_{3} \vert + {c}_{FF}^{R} * {ρ}_{1 , B} * ( \vert B \vert + \frac{\vert R1 \vert \vert R3 \vert}{\vert A \vert} )$$

3.1.3 Analysis of Join Processing

To examine the amount of data transmission cost incurred by J_{C} and J_{R}. Specifically, the criterion of identifying an effectual remote mobile join to reduce the amount of data transmission cost is derived. In practice, the local transmission cost coefficient between local mobile hosts and local fixed hosts c_{MLF}^{L} is very close to the value among local mobile hosts c_{MM}^{L}. To simplify our discussion, c_{MF}^{L}=c_{MM}^{L} and C_{MF}^{R}=C_{MM}^{R} are assumed in this disclosure. Note that such as assumption is made for ease of discussion and is not essential for the use of remote joins we propose in this invention.

Lemma 1.

$${c}_{FF}^{R} = \frac{{r}_{MM}^{RL}}{{r}_{MF}^{L}} * {c}_{MF}^{L} .$$

Lemma 2. With

$$\frac{{r}_{MF}^{R} * ( {r}_{MM}^{RL} - 1 )}{{r}_{MM}^{RL}} < {ρ}_{1 , B} * ( \frac{\vert R2 \vert}{\vert R3 \vert \vert} - \frac{R1 \vert}{\vert A \vert} ) ,$$

the amount of data transmission cost incurred by method J_{R} is smaller than that by method J_{C}, i.e., TC(J_{R})<TC(J_{C}), where R₂ is a remote fixed host and R₃ is an example of the local mobile host.

With Lemma 2, an effectual remote mobile join is defined as follows:

Definition 2. A remote mobile join is called effectual if and only if TC (J_{R}) is smaller than TC (J_{C})

With Definition 2, we can derive the following theorem. According to Theorem 1, effectual remote mobile joins can be interleaved into the query scheduling to reduce the data transmission cost of multijoin processing.

Theorem 1. A remote mobile join is effectual if and only if

$$\frac{{r}_{MF}^{R} * ( {r}_{MM}^{RL} - 1 )}{{r}_{MM}^{RL}} < {ρ}_{1 , B} * ( \frac{\vert R2 \vert}{\vert R3 \vert \vert} - \frac{R1 \vert}{\vert A \vert} ) ,$$

where |R₃| is the size of relations in a remote fixed host, ρ_{1,B} denotes the selectivity of a relation in the local fixed host, and |R₂| is the size of a relation in the local mobile host.

It can be verified that, by judiciously applying effectual remote mobile joins, method JR can reduce the amount of data transmission cost as a whole. As can been seen later, Theorem 1 derived above can be employed to determine the threshold for whether method JR should be utilized.

3.2 Query Processing with Divide-and-Conquer (Denoted by QP_{C})

Consider the illustrative query in FIG. 7 as an example where the destination site is F₁. In scheme QP_{C}, the J_{C} method is utilized. First, the query is divided into two subqueries and each subquery is processed with forward scheduling algorithm. In FIG. 8, Q_{S1} and Q_{S2} belong to Cell₁ and Cell₂, respectively. R₁, R₂, R₃, R4, R5, and R6 are located at Q_{S1} and R7, R8, R9, and R₁0, in contrast, belong to subquery Q_{S2}. After each partial result of subquery is generated, we merge these residue relations to be a new query. Then, the forward scheduling algorithm is utilized again for the new query processing. Note that, since the amount of |R_{F}|, where R_{F} denotes the relation in fixed hosts, is usually much larger than |R_{M}|, that is the relation in mobile host, the partial result of each subquery will be naturally located at the fixed host. Therefore, we assume that the query result R′₁ of Q_{S1} is located in F₁ and the result R′₇ of Q_{S2} is located in F₇. Consequently, the query result can be generated in F₁ by the final merging processing from R′₇ to R′₁. Such an adaptive version of conventional procedure denoted by QP_{C} can be outlined below. The concept of algorithm FS (standing for forward scheduling) is also presented.

Procedure QP_{C}: Determine the scheduling of multijoin queries based on the cell architecture.

Step 1: Based on cell architecture, divide the original query into several subqueries.

Step 2: Process each subquery with algorithm forward scheduling.

Step 3: Merge residue relations from each subquery into a new query, which is referred to as a conquer query.

Step 4: Do the query processing of the conquer query with forward scheduling algorithm again and generate the query result.

Step 5: Send the query result to the needed destination.

Algorithm Forward Scheduling (algorithm FS): Determine the join sequence starting from performing the minimum-cost join.

Step 51: Perform effectual semijoins in the query.

Step 52: With join processing, merge relations from the path of minimum transmission cost.

Step 53: Reorganize the query.

Step 54: If the query is empty, go to Step 55. Otherwise, go back to Step 52.

Step 55: End

### SUMMARY OF INVENTION

It is therefore a primary objective of the claimed invention to provide a method for processing distributed mobile queries in order to solve the above-mentioned problems.

According to the claimed invention, a method for processing distributed mobile queries includes analyzing distributed data stored in mobile and fixed hosts camped on a plurality of cells and merging data relations among mobile hosts not camped on a same cell. The claimed invention utilizes the fact that remote joins can be more cost effective than algorithms used in traditional distributed query processing.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram illustrating a mobile computing environment with mobile hosts and fixed hosts.

FIG. 2 is a chart showing an example of semijoin operations.

FIG. 3 is a chart describing symbols used to describe the cost model in a mobile computing system.

FIG. 4 illustrates an example scenario for join processing.

FIG. 5 illustrates a scenario of join processing with divide-and-conquer.

FIG. 6 illustrates a scenario of join processing with remote mobile joins.

FIG. 7 is a diagram illustrating division of a query in a mobile computing environment with mobile hosts and fixed hosts.

FIG. 8 illustrates query processing with QP_{C} methodology.

FIG. 9 illustrates query processing with QP_{R} methodology according to the present invention.

FIG. 10 shows steps used in query processing with QP_{R} methodology.

FIG. 11 is a chart showing default values of model parameters.

FIG. 12 and FIG. 13 show performance studies on various values of N_{M} in each cell.

FIG. 14 and FIG. 15 show performance studies on the density of query.

FIG. 16 and FIG. 17 show performance studies on the size of attribute cardinalities over the amount of relation tuples in mobile hosts.

FIG. 18 and FIG. 19 show performance studies on the ratio of relation tuples in fixed hosts over that in mobile hosts.

FIG. 20 and FIG. 21 show performance studies on transmission cost ratios between remote fixed hosts and local fixed hosts.

FIG. 22 and FIG. 23 show performance studies on transmission cost ratios between local mobile hosts and local fixed hosts.

FIG. 24 and FIG. 25 show performance studies on transmission cost ratios between remote mobile hosts and local mobile hosts.

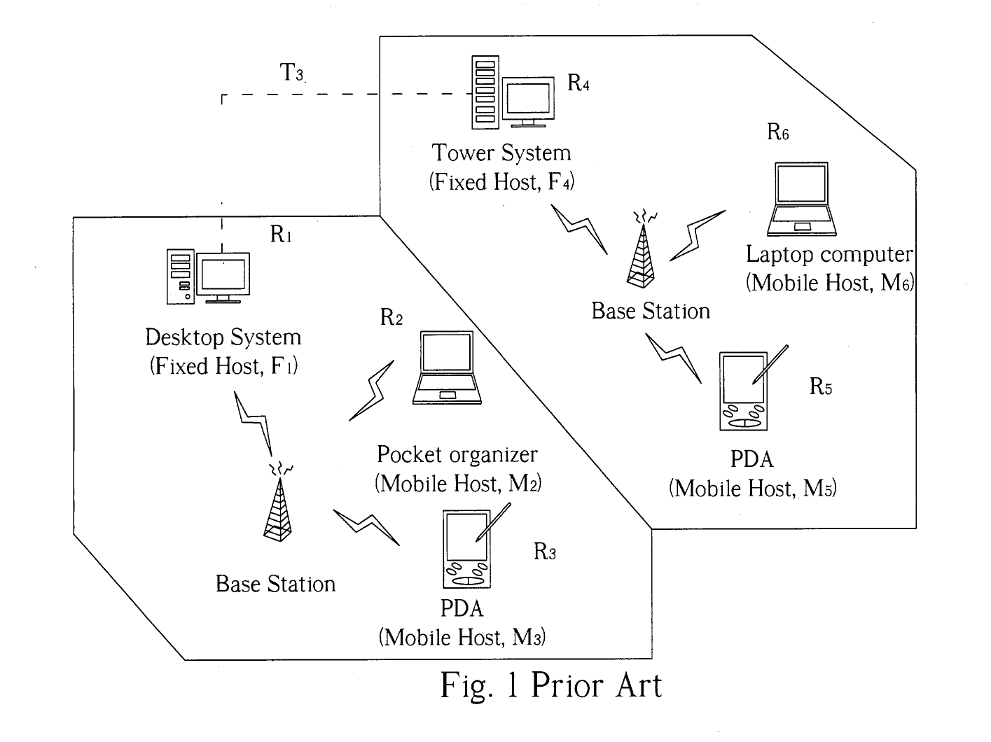

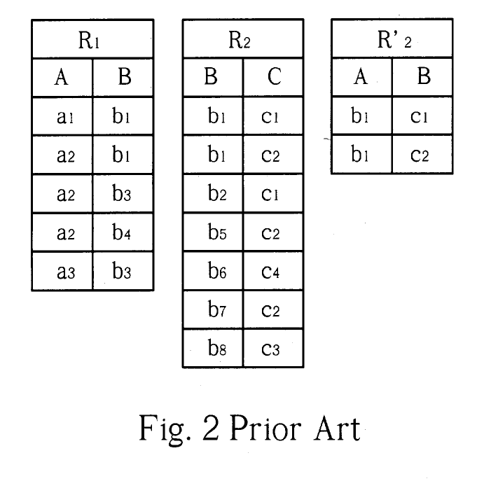

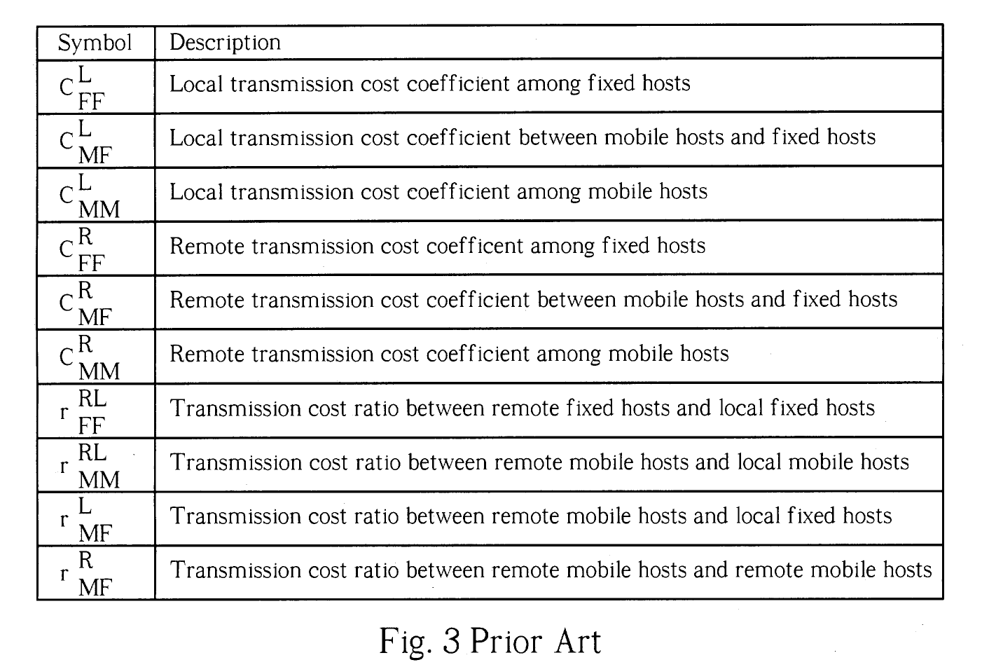

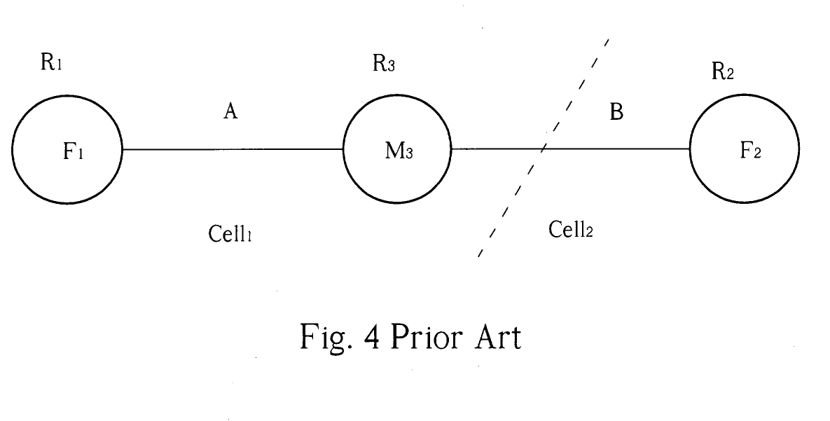

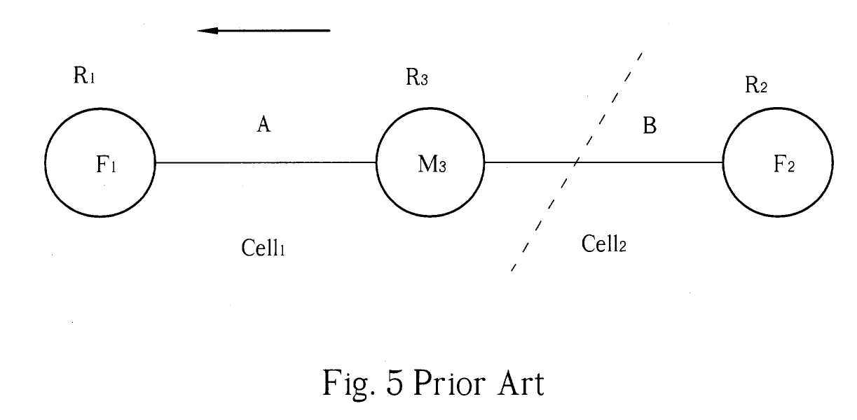

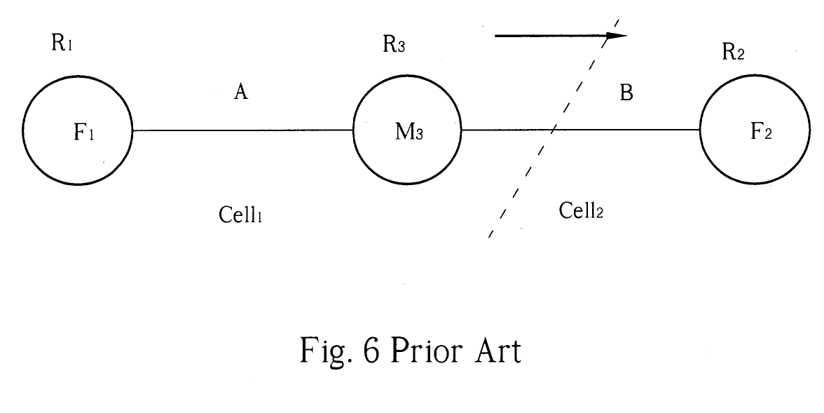

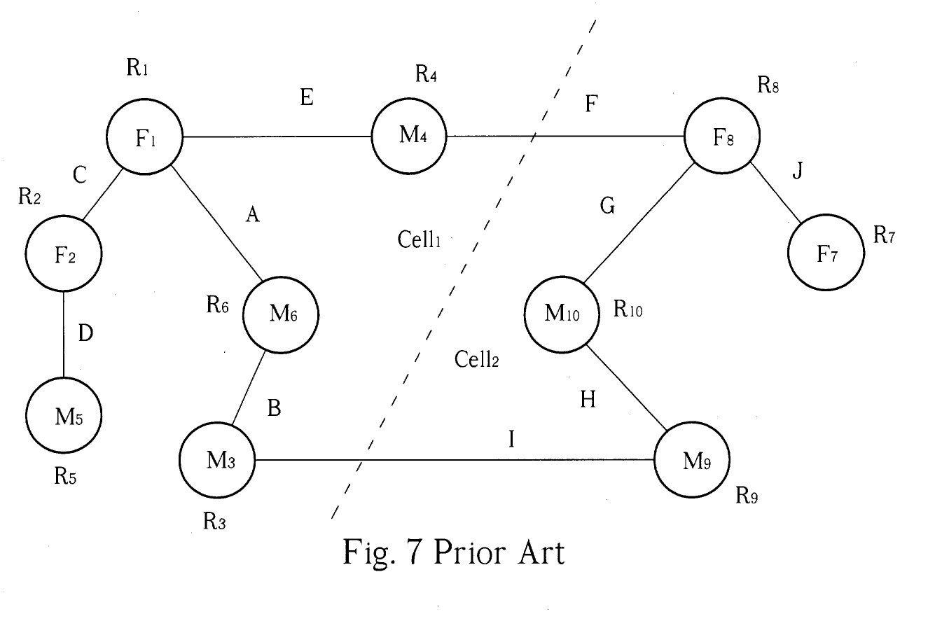

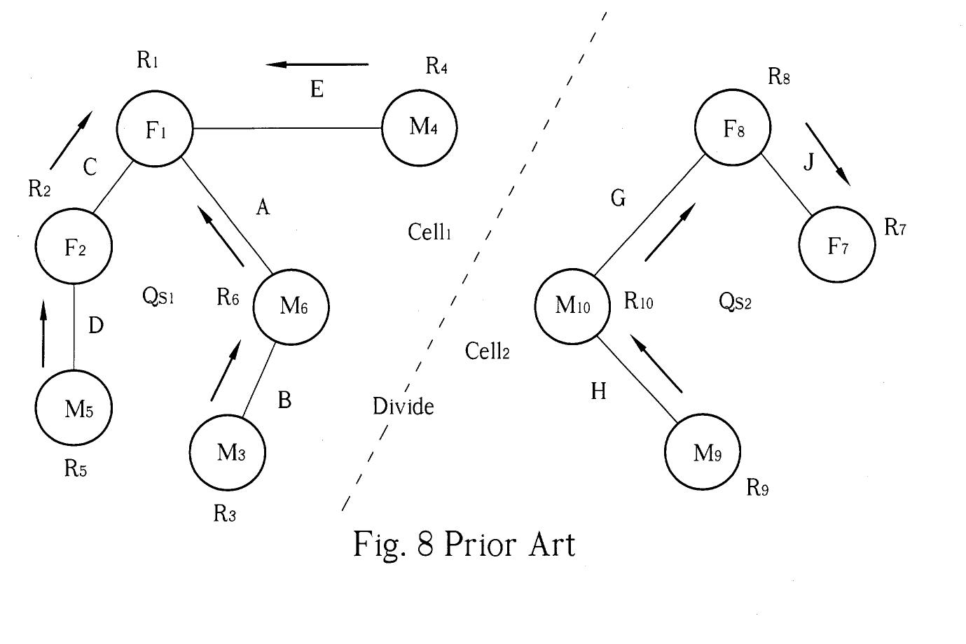

### DETAILED DESCRIPTION

3.3 Query Processing with Effectual Remote Mobile Joins (Denoted by QP_{R})

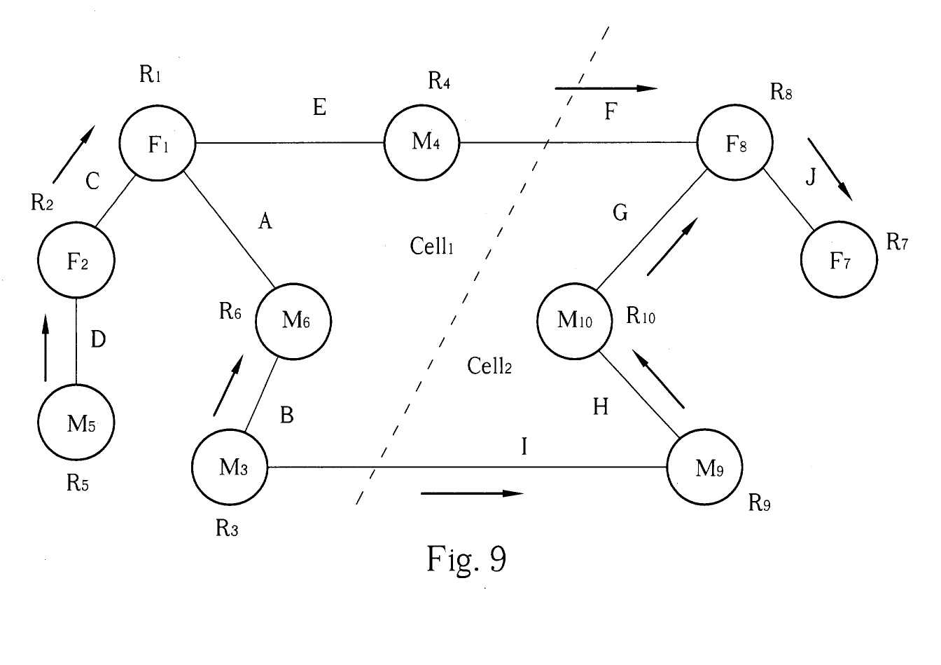

Clearly, scheme QP_{C} does not exploit the relationship among remote relations and may thus consume much valuable communication cost for the join processing in the merged query Q_{M}. Instead of partitioning the query into several subqueries based on the cell architecture, as in scheme QP_{C}, the concept of the effectual remote mobile join will be employed in algorithm QP_{R}. According to Theorem 1, an effectual remote mobile join can successfully reduce the transmission cost. The corresponding diagrams of each step in QP_{R} procedure are illustrated in FIG. 9. For ease of exposition, L_{d}( ) denotes a set of local joins in the destination cell and Lᵣ( ) is the set of local joins in a remote cell. In addition, R( ) represents a set of the remote joins across different cells. For example, L_{d}(RM, RM) denotes the set of joins among local mobile relations in the destination cell.

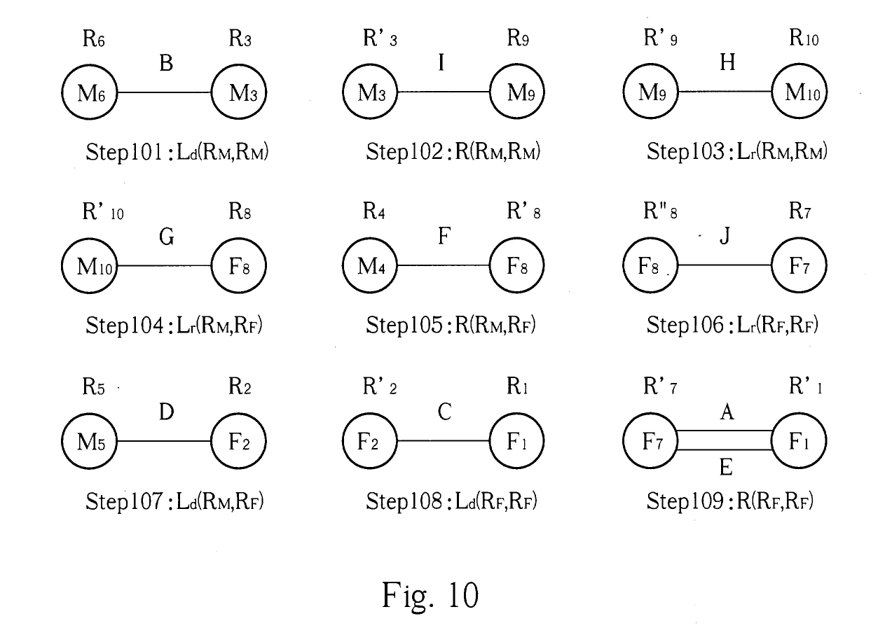

Please refer to FIG. 10. FIG. 10 shows steps used in query processing with QP_{R} methodology according to the present invention. First, in Step 101, connected relations among fixed hosts and mobile hosts in the cell of query destination are merged with algorithm FS. For ease of our discussion, we assume that the join result of R₆.B=R₃.B is merged to M₃. The relationship R′₃.I=R₉.I among mobile hosts located in different cells is exploited by the join processing in Step 102. The result is in M₉, as shown in Step 102, if R(RM, RM) can induce effectual remote mobile joins. In Step 103, we merge R′₉.H=R₁₀.H of the connected mobile hosts in remote cells to the mobile host M₁₀. Then, Step 104 shows that R′₁₀ is merged to the fixed host F₈. Using effectual remote mobile joins R(RM, RF) in Step 105, mobile relations in the local cell are merged into fixed hosts in the remote cell. Step 106 indicates the operation of merge relations in remote fixed hosts to F₇. Furthermore, the merge operations among local mobile hosts and local fixed hosts are performed in Step 107. Similarly, the merged result R′₂ is assumed to be located in F₂. Then, we merge relations of the fixed hosts in the local cell to F₁ with L_{d}(RF, RF) in Step 108. Finally, Step 109 illustrates the final step of merging the relations in remote fixed hosts to the local fixed host F₁. Procedure QP_{R} is outlined below. Note that, in each step, the merging processing is based on algorithm FS.

Procedure QP_{R}:

Determine the scheduling of multijoin queries with remote mobile joins

Step 101: Merge relations in mobile hosts which are connected with each other in the destination cell of query. That is, perform the joins in the set of L_{d}(RM, RM);

Step 102: If there exist effectual remote mobile joins among relations in mobile hosts, merge those relations to the mobile hosts in remote cell. That is, perform the joins in the set of R(RM, RM);

Step 103: Merge relations in mobile hosts which are connected with each other in remote cells. That is, perform the joins in the set of Lᵣ(RM, RM);

Step 104: Merge relations from mobile hosts to fixed hosts, where mobile hosts and fixed hosts are connected with each other in remote cells. That is, perform the joins in the set of Lᵣ(RM, RF);

Step 105: If there exist effectual remote mobile joins among mobile hosts and fixed hosts, merge relation in mobile hosts of the destination cell to the fixed hosts in remote cells. That is, perform the joins in the set of R(RM, RF);

Step 106: Merge relations in fixed hosts which are connected with each other in remote cells. That is, perform the joins in the set of Lᵣ(RF, RF);

Step 107: Merge relations from mobile hosts to fixed hosts, where mobile hosts and fixed hosts are in the destination cell of query. That is, perform the joins in the set of L_{d}(RM, RF);

Step 108: Merge relations in fixed hosts which are in the destination cell of query. That is, perform the joins in the set of L_{d}(RF, RF);

Step 109: Merge residue relations in fixed hosts to the fixed host of the destination cell. That is, perform the joins in the set of R(RF, RF);

3.4 Analysis of Solution Space

Assume that there are N_{cell} cells in a mobile network and each cell is of N_{Mobile} mobile hosts and N_{Fixed} hosts. In essence, according to the traditional query processing technique, i.e., FS-like algorithm as mentioned above, the size of solution space could be up to O(((N_{Mobile}+N_{Fixed})*N_{cell})!). On the other hand, algorithm QP_{C} merges those relations in each cell separately by algorithm FS in advance, followed by the employment of another FS process to merge those sub-query results of each cell as the final query solution. The size of solution space of QP_{C} is therefore O((N_{Mobile}+N_{Fixed})!*N_{cell})!) It is noted that the QP_{C} is more efficient than those traditional query processing algorithms in the wireless mobile computing environment. As compared to algorithm QP_{C}, QP_{R} utilizes a larger searching space. However, as will be seen in our experimental studies, judiciously applying effectual remote mobile joins, algorithm QP_{R} can significantly reduce the amount of data transmission cost as a whole.

4 Experimental Studies

As shown in our previous analysis, in such mobile environments, the query processing, enhanced with useful features of wireless technology and mobility of mobile units, provides a new interesting dimension beyond traditional distributed computing systems. The applications of processing distributed mobile queries with interleaved remote mobile joins can be well developed, for example, in a telecommunication alarm system. With wireless communication technologies, the newly explored information in remote mobile devices can also be applied to online services.

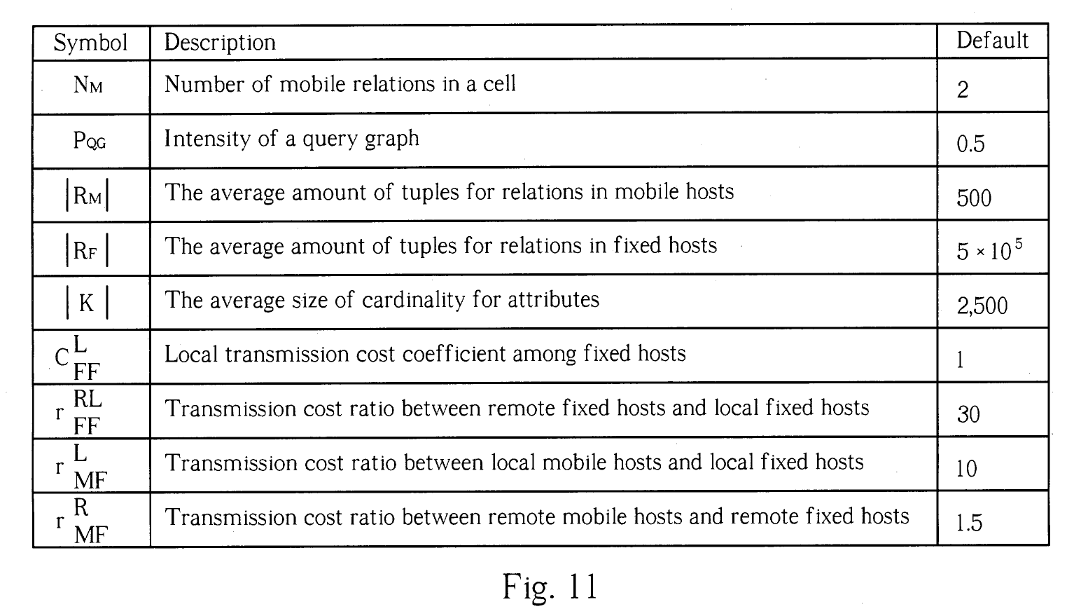

For obtaining reliable experimental results, the method to generate synthetic query processing we employed in this study is similar to the ones used in prior works. Simulations were performed to evaluate the effectiveness of join processing methods and query processing schemes. The simulation program was coded in C++ and input queries were generated as follows: The number of relations in a query was predetermined. The occurrence of an edge between two relations in the query graph was determined according to a given probability, denoted by p_{QG}. Without loss of generality, only queries with connected query graphs were deemed valid and used for our study. Based on the above, the cardinalities of relations and attributes were randomly generated from a uniform distribution within some reasonable ranges. These settings are similar to those prior works in query processing. To concentrate our evaluation, the number of cells to be evaluated is assumed to be two and only one fixed server host is located in each communication cell. In addition to two mobile hosts in each cell, we also assume that each host only contains one relation. With merge operations, we can merge several fixed hosts in the same cell together and combine several remote cells to be one unit of cell. As such, despite its simplicity, our model can still reflect the reality. For ease of exposition, unless mentioned otherwise, the default value of each parameter is given in FIG. 11. The selectivity of relation attributes in mobile hosts is randomly generated in the range of 0.1 to 0.2, while that in fixed hosts is in the range of 0.8 to 0.95. In addition, the communication costs across remote hosts are more expensive than those across local hosts. Thus, r_{FF}^{RL} and r_{MM}^{RL} are, in general, larger than one, e.g., r_{FF}^{RL}=30 and r_{MM}^{RL}=10 in Taiwan telecommunication service. Similarly, r_{MF}^{R}=1.5 and r_{MF}^{L}=4.5 are larger than one due to the asymmetry features between mobile hosts and fixed hosts. Moreover, the density of query is given as P_{QG}=0.5 and each execution cost is the result of the average from 20 query executions. To simplify our presentation, the execution cost of algorithms A denoted by Cost (A), where A can be QP_{C} or QP_{R}. To exhibit the benefit of relation replication, the reduction ratio

$${R}_{CR} = \vert \frac{Cost ( Q {P}_{C} ) - Cost ( Q {P}_{R} )}{Cost ( Q {P}_{C} )} \vert$$

is used as a metric to compare QP_{C} and QP_{R}.

Even though many prior studies have developed several efficient algorithms for join or semijoin processing, little work has taken both the network topology and the limitation on network bandwidth into consideration. In accordance with the cost model proposed in the present invention, the algorithm QP_{C}, our proposed algorithm, can be taken as one kind of the extended schemes from the conventional query processing. Furthermore, as in most previous works in distributed query processing, averages are taken over absolute query execution costs. Performance comparison on execution costs of queries originating from different sites is, in fact, a system-dependent issue and is beyond the scope of this disclosure. Without loss of generality, we assume the temporal-final query result will be located at a dedicated fixed host. Then, the final query result will be transmitted to the original host of the query.

Our results demonstrate the effectiveness of our effectual remote mobile joins in the distributed mobile query processing as taking the network topology into consideration. Extensive performance studies are conducted. Sensitivity analysis on various parameters, including number of mobile hosts in a cell, the density of query, the amount of tuples in a relation, the size of relation cardinality, and transmission cost coefficients in a mobile computing network is conducted.

4.1 Experiment One: Evaluating Number of Mobile Relations in Each Cell

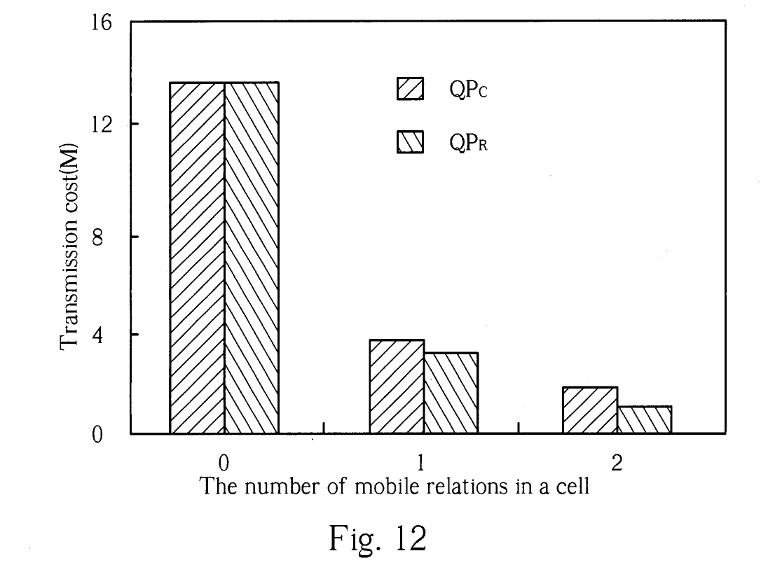

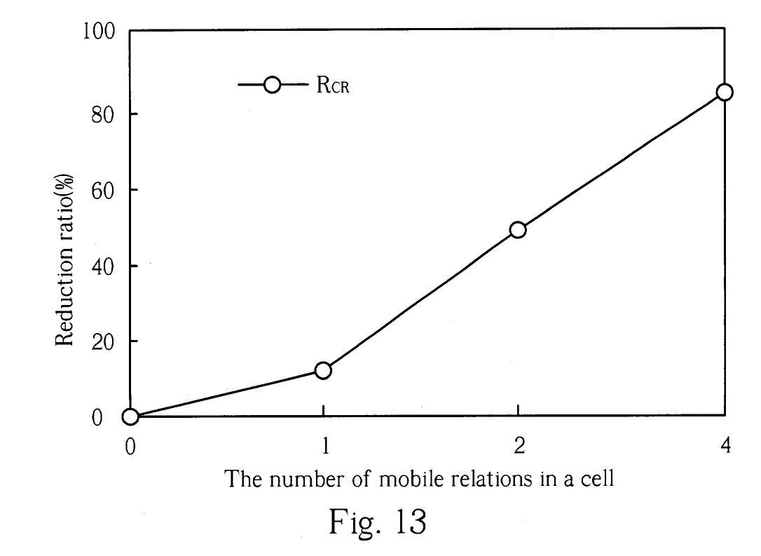

FIG. 9 shows the performance results for the number of mobile relations N_{M} in each cell. Explicitly, since mobile relations are employed as reducers in our proposed query processing cost model, more mobile joins in the query processing lead to less data transmitted through the network. In other words, more mobile relations in a cell will lead to a higher likelihood of having the effectual mobile joins as reducers in the query processing. As a result, with the growth of N_{M} in each cell, the transmission costs required by both algorithms QP_{C} and QP_{R} decrease, as shown in FIG. 12. In FIG. 13, it can be seen that, with the presence of effectual remote mobile joins, QP_{R} outperforms QP_{C}. A higher reduction ratio R_{CR} is observed for large numbers of N_{M}.

4.2 Experiment Two: Performance Studies for Density of Query

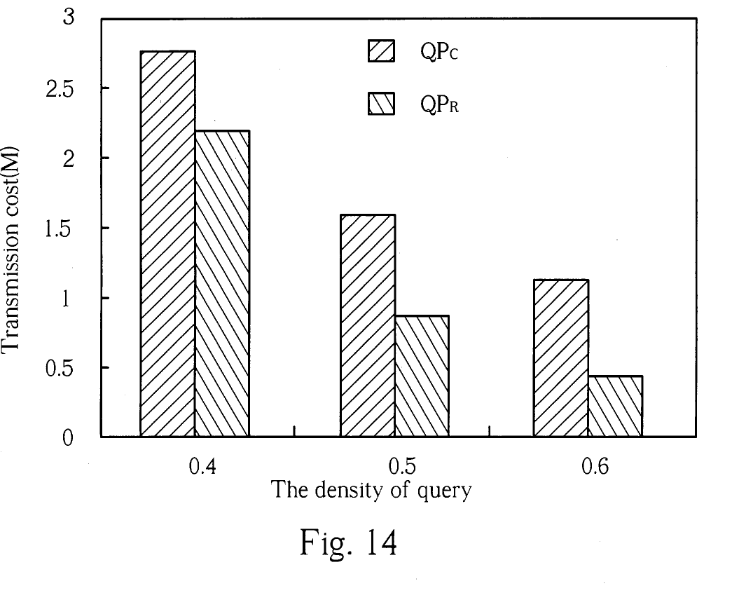

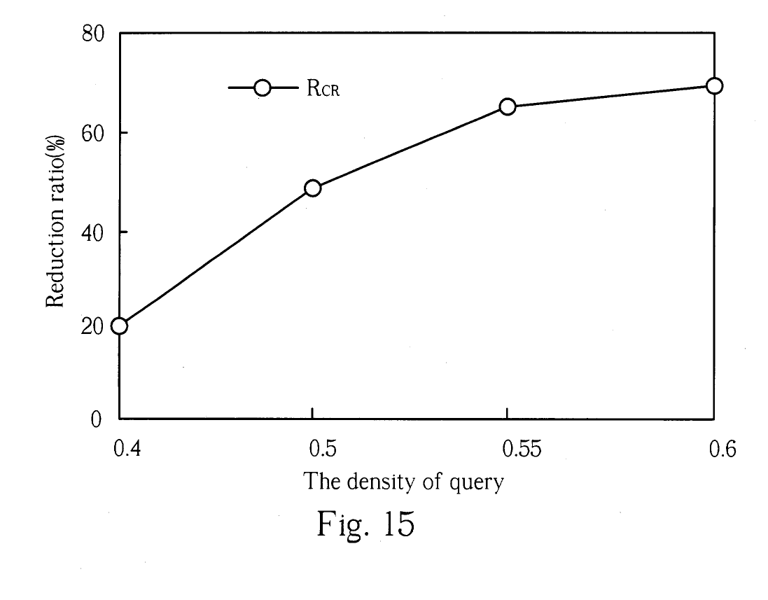

In this experiment, we analyze the contribution of the density of query P_{QG} in algorithms QP_{C} and QP_{R}. In FIG. 14, it can be seen that the execution results of both algorithms improves when the connected probability among relations increases. Statistically, a larger value of P_{QG} leads to a higher possibility of having effectual mobile joins, including local and remote mobile joins. Thus, both QP_{C} and QP_{R} improve with the growth of query density. However, QP_{R} performs better with the extra benefit from effectual remote mobile joins, as shown in FIG. 15.

4.3 Experiment Three: Evaluation on the Attribute Cardinalities

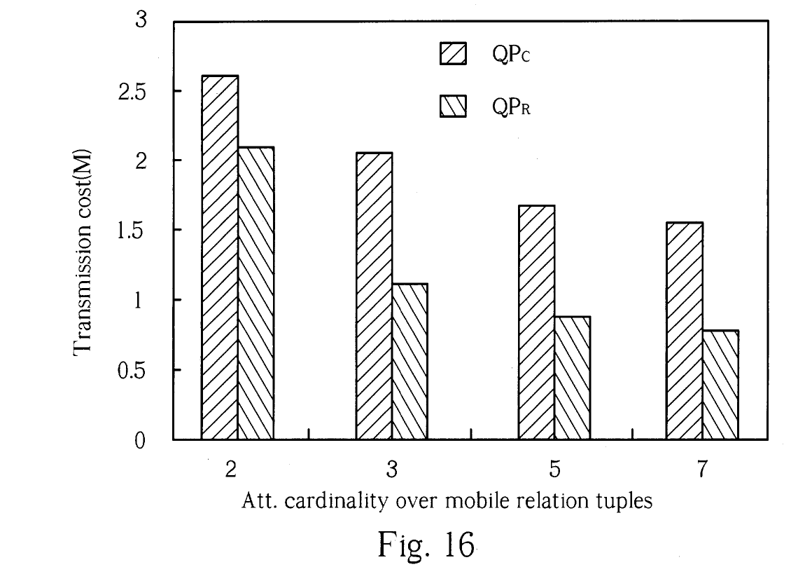

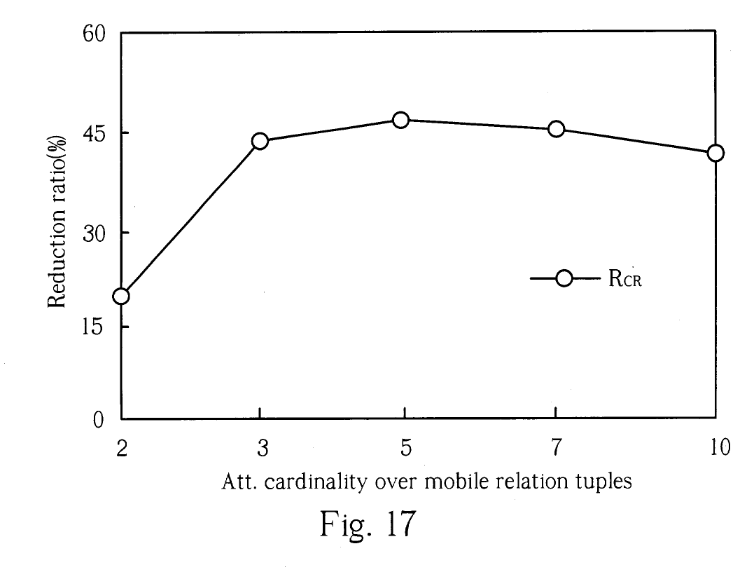

FIG. 11 shows the performance results for the ratio of attribute cardinalities over the amount of relation tuples in the mobile hosts. Consequently, with the growth of attribute cardinalities, both of the transmission costs of QP_{C} and QP_{R} decrease, as shown in FIG. 16. FIG. 17 shows that, due to the use of the remote mobile joins, the advantage of QP_{R} over QP_{C} increases as the number of attribute cardinalities increases. However, once the size of attribute cardinality grows over a threshold ratio of the amount of relation tuples in mobile hosts, the effect of cost reduction achieved by using remote mobile joins will become saturated.

4.4 Experiment Four: Evaluating Tuples Ratio between Fixed Hosts and Mobile Hosts

The horizontal axis in FIG. 12 indicates the value of

$$\frac{\vert {R}_{F} \vert}{\vert {R}_{M} \vert} .$$

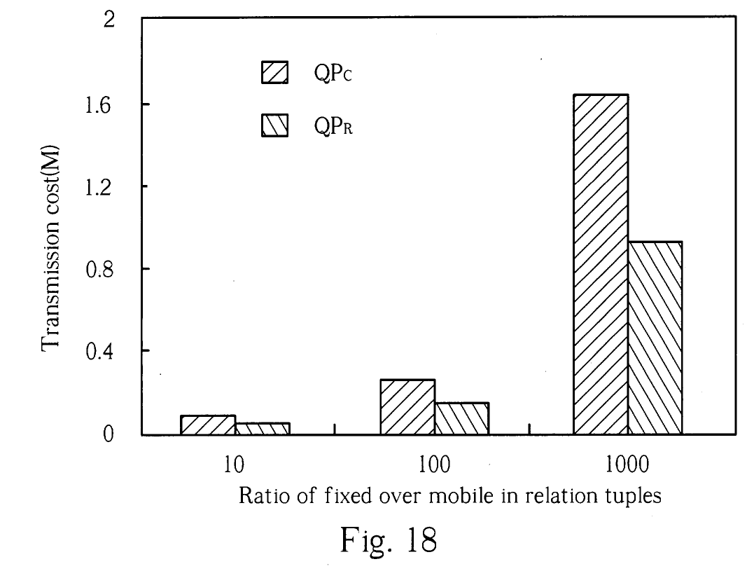

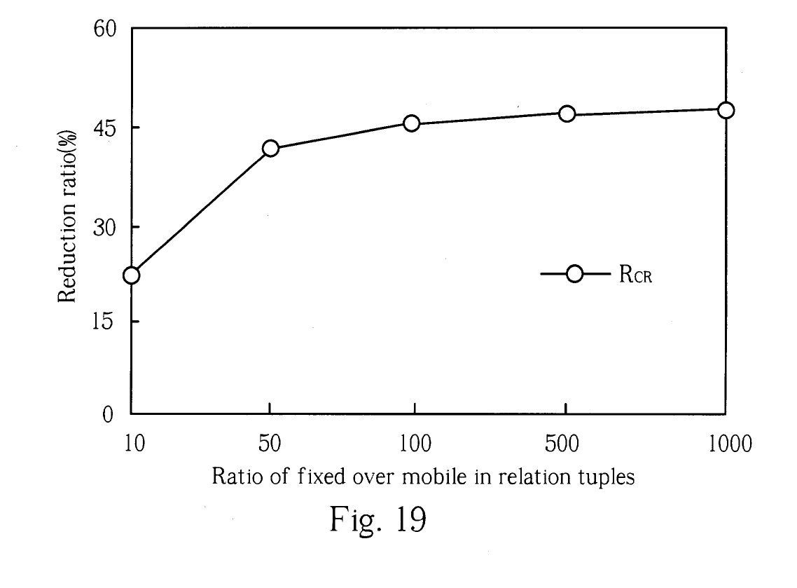

With fixed size of the relation tuples in mobile hosts, the increase of the number of tuples in fixed hosts will lead to more transmission costs required in the query processing of both QP_{C} and QP_{R}, as shown in FIG. 18. Specifically, as shown in FIG. 19, QP_{R} exhibits a better scheduling than QP_{C} for a multijoin query processing with the growth of

$$\frac{\vert {R}_{F} \vert}{\vert {R}_{M} \vert} .$$

Note that effectual remote mobile joins are more powerful for dealing with the large amount of relation tuples in remote fixed hosts, thereby reducing the amount of data transmission costs incurred. Consequently, QP_{R} can lead to the design of an efficient and effective query processing procedure for a mobile computing environment.

4.5 Experiment Five: Evaluation on the Transmission Cost Ratio

Several parameters, as known, are used to be the transmission cost coefficients in a mobile computing environment. In this experiment, we will show that these assumptions have less influence on the efficiency of our algorithms. FIG. 13 shows the experimental results with various values of r_{FF}^{RL} while FIG. 14 shows the performance studies with various values of r_{MF}^{L}. Moreover, the performance studies about r_{MF}^{R} are also given in FIG. 15. Since r_{MF}^{R}*r_{FF}^{RL}=r_{MM}^{RL}*r_{MF}^{L}, as discussed in the cost model, the transmission cost ratio between remote mobile hosts and local mobile hosts, i.e., r_{MM}^{RL}, can be derived and

$${r}_{MM}^{RL} = \frac{{r}_{MF}^{R} * {r}_{FF}^{RL}}{{r}_{MF}^{L}} .$$

Similar scenarios were observed when r_{MM}^{RL} was evaluated.

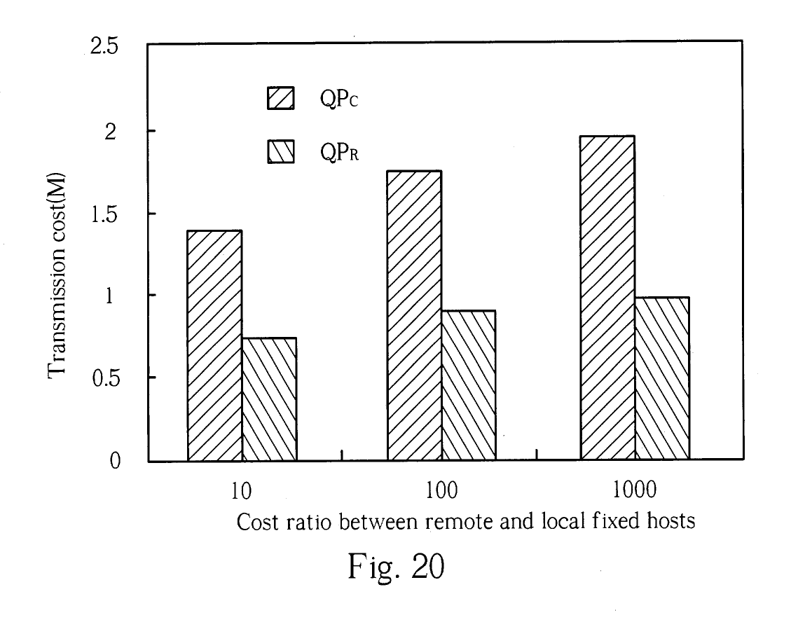

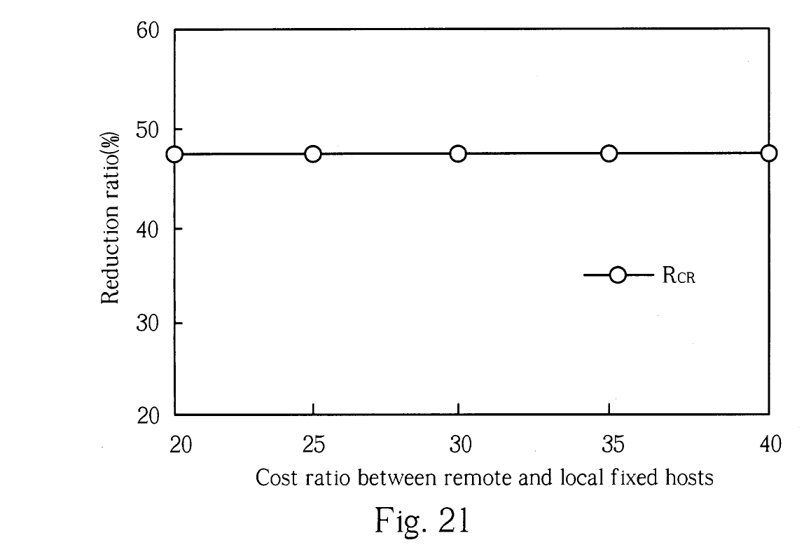

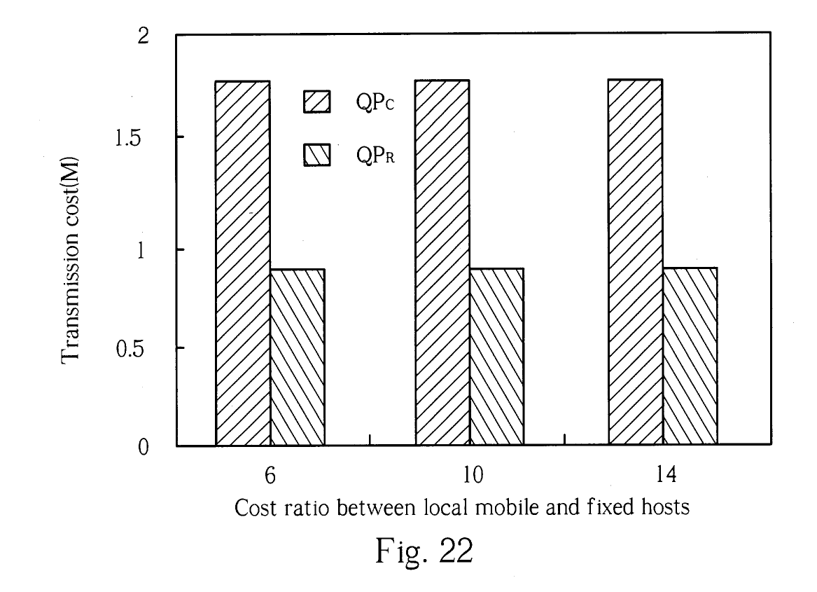

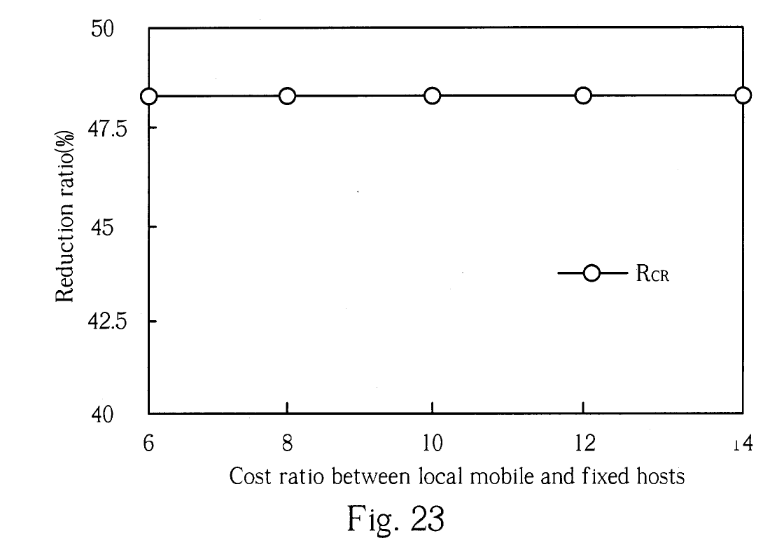

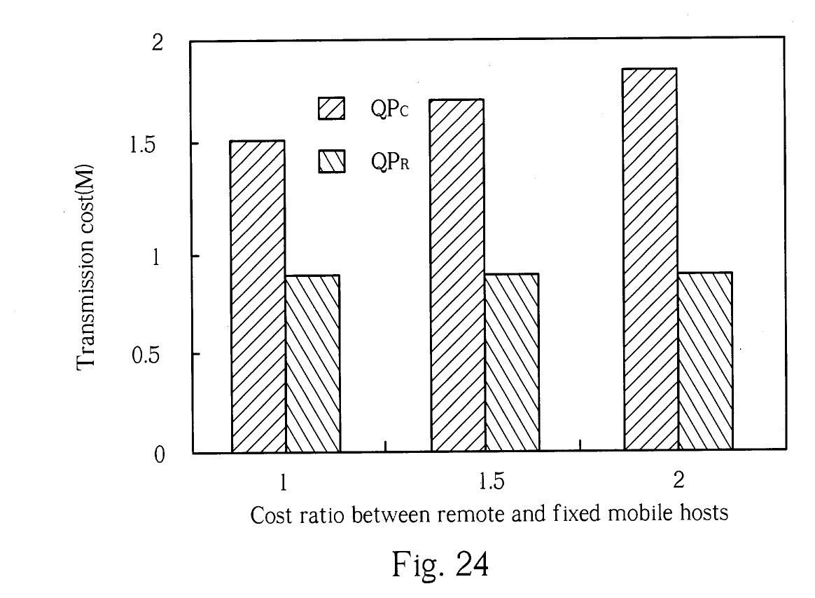

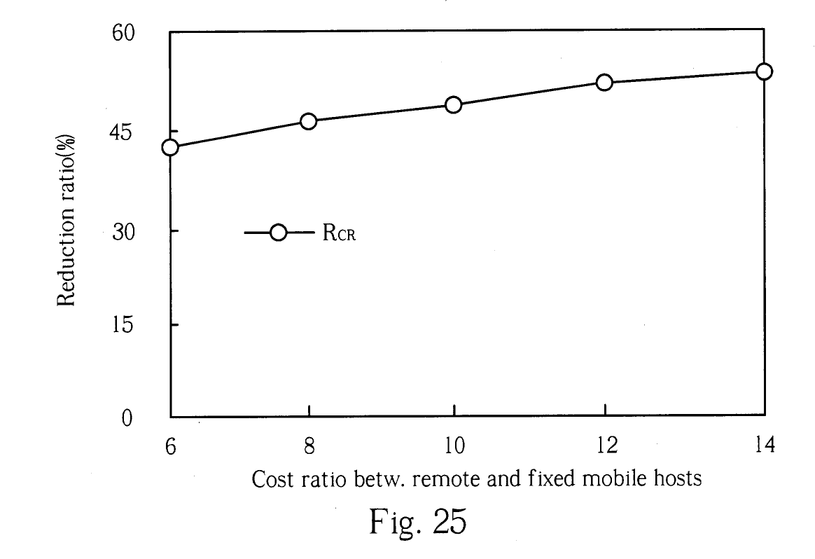

With the increase of r_{FF}^{RL}, it can be seen that the transmission coefficient among remote fixed hosts, i.e., c_{FF}^{R}=r_{FF}^{RL}*c_{FF}^{L}, gets higher. Thus, the total transmission costs required by both of QP_{C} and QP_{R} increase, as shown in FIG. 20. However, since |R_{F}| is, in general, large, the reduction ratio R_{CR} is less affected by r_{FF}^{RL}. Thus, R_{CR} just slightly increases with the growth of r_{MF}^{L} in FIG. 21. Similarly, because the number of relation tuples in mobile hosts is small as compared to that in fixed hosts, the reduction ratio R_{CR} remains unchanged with the growth of r_{MF}^{L} as shown in FIG. 23. Even though higher r_{MF}^{L} will also lead to the increase of total transmission costs caused by QP_{C} and QP_{R}, the total transmission cost of query processing is orthogonal to the value of r_{MF}^{L}, as shown in FIG. 14. Furthermore, due to the advantage of using remote mobile joins in QP_{R}, R_{CR} increases slightly in FIG. 25.

### 5 CONCLUSIONS

We have explored some unique features of a mobile environment and then, in light of these features, we devised query processing methods for both join and query processing. Remote mobile joins were said to be effectual if they were, when interleaved into a join sequence, able to reduce the amount of data transmission cost required for distributed mobile query processing. Since mobile relations were employed as reducers in our proposed query processing cost model, more mobile joins in the query processing led to less data transmitted through the network. Judiciously interleaving effectual remote mobile joins into a query scheduling can significantly reduce the total amount of data communication among different cells. It was verified that the total data transmission cost of the processing in a distributed mobile query was reduced by the algorithms designed by using effectual remote joins. Performance studies on the sensitivity of various important parameters, including the number of mobile relations in a cell architecture, the density of query, the size of relation tuples, attribute cardinalities, and network transmission coefficients in a mobile computing model were also conducted.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for processing distributed mobile queries, the method comprising:
(a) analyzing distributed data stored in mobile and fixed hosts camped on a plurality of cells; and
(b) merging data relations among mobile hosts not camped on a same cell.

2. The method of claim 1 further comprising:
(c) merging data relations among mobile hosts camped on a same remote cell.

3. The method of claim 1 further comprising:
(d) merging data relations among mobile hosts camped on a same destination cell.

4. The method of claim 1 further comprising:
(e) merging data relations from at least one mobile host to at least one fixed host, wherein the mobile host and fixed host are camped on a same remote cell.

5. The method of claim 1 further comprising:
(f) merging data relations from at least one mobile host to at least one fixed host, wherein the mobile host is camped on a destination cell and the fixed host is camped on a remote cell.

6. The method of claim 1 further comprising:
(g) merging data relations among fixed hosts camped on a same remote cell.

7. The method of claim 1 further comprising:
(h) merging data relations from at least fixed host camped on a remote cell to at least one fixed host camped on a destination cell.

8. The method of claim 1 further comprising:
(i) merging data relations from at least one mobile host to at least one fixed host, wherein the mobile host and fixed host are camped on a same destination cell.

9. The method of claim 1 further comprising:
(j) merging data relations among fixed hosts camped on a same destination cell.
